(19) United States
(12) Patent Application Publication
(10) Pub. No.: US 2022/0245601 A1
(43) Pub. Date: Aug. 4, 2022

(54) Methods And Systems For Remotely Authorizing Transactions

(71) Applicant: Integrated Media Management, LLC, Rahway, NJ (US)

(72) Inventors: Nishit Shah, Monroe, NJ (US); David Aranovsky, Staten Island, NY (US); John A. Levy, West Allenhurst, NJ (US)

(73) Assignee: Integrated Media Management, LLC, Rahway, NJ (US)

(21) Appl. No.: 17/162,199

(22) Filed: Jan. 29, 2021

(51) Int. Cl. G06Q 20/02; H04L 29/06; G06Q 20/38; G06Q 20/32; G06Q 20/10; G06F 16/27; H04L 29/08; G06F 3/0488; H04L 12/66

(52) U.S. Cl. CPC G06Q 20/02; H04L 63/08; G06Q 20/3825; G06Q 20/322; G06Q 20/3255; H04L 12/66; G06Q 20/389; G06F 16/27; H04L 67/02; G06F 3/04883; G06Q 20/1085

(57) ABSTRACT

A system and associated method for authorizing a transaction between a teller device and a user device is disclosed. The system can include a teller device configured to generate a remote signing notification. The system can include a server device configured to receive the remote signing notification from the teller device and generate a transaction document based on the remote signing notification. The system can include a user device configured to display a webpage based on the URI and perform a signature in the signature section of the webpage and transmit the signature from the user device to the server device to authorize the transaction.

### FIELD

The present disclosure relates to methods and systems for remotely authorizing transactions.

### BACKGROUND

Institutions such as banks & credit unions may require customers/members signature to authorize certain transactions while physically coming into the institution or using drive through services. Customer/members sign the transfer/withdrawal slip on paper or paper receipt after the institution has performed a transaction in their system. Having to be physically located in the vicinity of institutions to perform the signature can be burdensome/problematic on customers/members.

The present invention solves this problem by electronically capturing signatures regardless of where the customer/member may be located (e.g. at socially distanced in-branch, drive-thru, home, etc.) and authorizing transactions.

### SUMMARY

A computer-implemented method for authorizing a transaction between a teller device and a user device is disclosed. The method may include generating, by a teller device, a remote signing notification that includes transaction information associated with the transaction, user information associated with the user device and teller device information associated with the teller device, and transmitting the remote signing notification from the teller device to a server device.

The method may include generating, by the server device, a transaction document based on the remote signing notification, the transaction document including at least a part of each of the transaction information, the user information, the teller device information, and a first authentication token, and storing the transaction document and the first authentication token in a database associated with the server device.

The method may include generating, by the server device, a uniform resource identifier (URI) and a second authentication token based on the transaction document, and transmitting, via a messaging gateway, the URI and the second authentication token from the server device to the user device.

The method may include requesting, by the user device, the first authentication token that is stored in the database of the server device, and determining whether a match exists between the first authentication token and the second authentication token, wherein when the match exists, transmitting the transaction document from the server device to the user device.

The method may include displaying, at the user device, a webpage based on the URI, wherein the webpage includes the transaction document and a signature section; performing, by the user device, a signature in the signature section and transmitting the signature from the user device to the server device; and transmitting the signature from the server device to the teller device for authorizing the transaction.

In various example embodiments, the user information can be the user's phone number. The transaction information can include a transaction identifier, transaction amount and user's account information. The transaction document can expire after a period. The messaging gateway can be a short message service (SMS) gateway. The uniform resource identifier (URI) can be a uniform resource locater (URL). The user device can be a mobile device. The signature can be performed via a touchscreen input at the user device. The signature can be passed on to the teller device via the server device. The database associated with the server device can be based on distributed ledger.

A system for authorizing a transaction between a teller device and a user device is disclosed. The system can include a teller device configured to generate a remote signing notification that includes transaction information associated with the transaction, user information associated with the user device and teller device information associated with the teller device.

The system can include a server device configured to: receive the remote signing notification from the teller device and generate a transaction document based on the remote signing notification, the transaction document including at least a part of each of the transaction information, the user information, the teller device information, and a first authentication token, store the transaction document and the first authentication token in a database associated with the server device, generate a uniform resource identifier (URI) and a second authentication token based on the transaction document, and transmit, via a messaging gateway, the URI and the second authentication token.

The system can include a user device configured to: receive the second authentication token from the server device, receive the first authentication token that is stored in the database of the server device, to determine whether a match exists between the first authentication token and the second authentication token, wherein when the match exists, transmit the transaction document from the server device to the user device, display a webpage based on the URI, wherein the webpage includes the transaction document and a signature section, and perform a signature in the signature section and transmit the signature from the user device to the server device, wherein the server device transmits the signature to the teller device to authorize the transaction.

### BRIEF DESCRIPTION OF DRAWINGS

Other objects and advantages of the present disclosure will become apparent to those skilled in the art upon reading the following detailed description of example embodiments, in conjunction with the accompanying drawings, in which like reference numerals have been used to designate like elements, and in which:

FIG. 1 shows a flowchart of a method authorizing a transaction between a teller device and a user device according to an example embodiment of the present disclosure;

FIG. 2 illustrates a transaction document according to an example embodiment of the present disclosure;

FIG. 3 shows an interface at the teller device according to an example embodiment of the present disclosure;

FIG. 4 illustrates a message received at a user device's interface according to an example embodiment of the present disclosure;

FIG. 5A shows an example display of a webpage at a user device with a blank signature section according to an embodiment of the present disclosure;

FIG. 5B shows the signature section after the signature has been performed at the user device according to an embodiment of the present disclosure;

FIG. 6 illustrates flowchart of a method for uroflowmetry according to an embodiment of the present disclosure;

FIG. 7 shows an example receipt of the authorized transaction according to an embodiment of the present disclosure;

FIG. 8 illustrates a system diagram for authorizing a transaction between a teller device and a user device according to an embodiment of the present disclosure;

FIG. 9 illustrates a system diagram for authorizing a transaction between a teller device and a user device according to an embodiment of the present disclosure; and

FIG. 10 illustrates an example of a machine configured to perform computing operations according to an embodiment of the present disclosure.

### DESCRIPTION

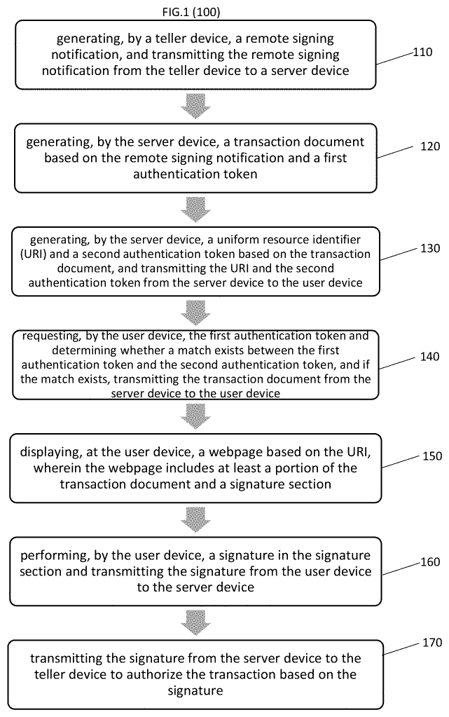

FIG. 1 shows a flowchart for an example method 100 for authorizing a transaction between a teller device and a user device. A teller device, as used herein, can be an electronic telecommunications device (e.g. ATM) that enables customers of financial institutions to perform financial transactions, such as cash withdrawals, deposits, funds transfers, or account information inquiries with or without human assistance. A user device, as used herein, can include an electronic device used by a customer/member/user to perform the transaction.

The method 100 may include a step 110 of generating, by the teller device, a remote signing notification that includes transaction information associated with the transaction, user information associated with the user device and teller device information associated with the teller device. Information on the remote signing notification can be manually input by a human user of the teller device and/or auto populated.

In an example embodiment, the transaction information can include a unique transaction identifier, a transaction amount, etc. The user information can include a user identifier such as user's name, phone number, address, account information, etc. The teller device information can include a unique identifier associated with the teller device.

The step 110 can further include transmitting the remote signing notification from the teller device to a server device, which can be a computer hardware or software (computer program) that provides functionality for client programs or devices (e.g. user/teller device). The server device can provide various functionalities such as sharing data or resources among multiple clients or performing computation for a client.

The method 100 may include a step 120 of generating, by the server device, a transaction document based on the remote signing notification, the transaction document including at least a part of each of the transaction information, the user information, the teller device information, and a first authentication token. The transaction document can be an electronic document that includes textual and/or visual information. The transaction document may expire after a period of time. An authentication token, as used herein, can be a random and unique number generated on an ad-hoc basis.

The step 120 can further include storing the transaction document and the first authentication token in a database associated with the server device. The database can be in various known forms such as a relational database, cloud database, in-memory database, etc. The database can utilize improved data structures having prioritized form fields which provide for more efficient use of computing resources, including more efficient use of the processor, memory and network communications.

The database can be in the form of a distributed ledger (e.g. blockchain) distributed among the multiple agents on a peer-to-peer network. Blockchain, as used herein, can be a ledger of all transactions of a blockchain-based data storage. One or more computing devices may comprise a blockchain network, which may be configured to process and record transactions as part of a block in the blockchain. Once a block is completed, the block can be added to the blockchain and the transaction record is thereby updated.

Blockchain may be a ledger of transactions in chronological order or may be presented in any order that may be suitable for use by the blockchain network. Blockchain may also include data as a form of transaction that maintains a continuously growing list of data records hardened against tampering and revision. The transaction may be confirmed and validated by the blockchain network through proof of work and/or any suitable verification techniques associated therewith. In some cases, data regarding a given transaction may further include additional data that is not directly part of the transaction appended to transaction data.

The method 100 may include a step 130 of generating, by the server device, a uniform resource identifier (URI) and a second authentication token based on the transaction document, and transmitting, via a messaging gateway, the URI and the second authentication token from the server device to the user device.

The method 100 may include a step 140 of requesting, by the user device, the first authentication token that is stored in the database of the server device and determining whether a match exists between the first authentication token and the second authentication token. If the match exists, transmitting the transaction document from the server device to the user device.

The method 100 may include a step 150 of displaying, at the user device, a webpage based on the URI, wherein the webpage includes the transaction document and a signature section. The method 100 may include a step 160 performing, by the user device, a signature in the signature section and transmitting the signature from the user device to the server device. The signature may be performed by a touch screen input such as a finger input, stylus pen, etc. The method 100 may include a step 170 transmitting the signature from the server device to the teller device for authorizing the transaction based on the signature. Step 170 may further include archiving/auditing/saving a copy of the authorized transaction.

A person of ordinary skill in the art would appreciate that the steps 110 to 170 of the method 100 can be performed, but are not required to be performed, in the order as shown in the FIG. 1 or as described. The steps 110 to 170 can be performed in any order that accomplishes the intended purpose of the method 100.

Aspects of method 100 can provide improved user interfaces, user experience and user interactions with computer generated interfaces for transactions between a teller device and a user device. Method 100 is rooted in computer technology involving specific computer components, intercommunications between computing modules, data structures and logic structures which improve the operation of the computer and also improve the technologies and technical fields previously described.

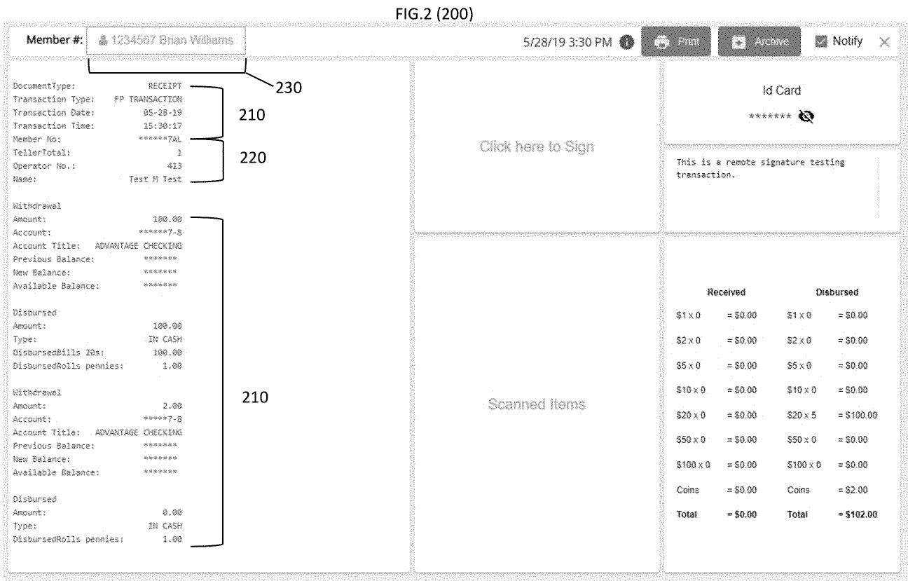

FIG. 2 shows an example transaction document as described in step 120. In a non-limiting exemplary embodiment, this transaction document may have transaction information 210 in the form of transaction type, transaction date, transaction time, received amount, type, hold quantity, ref number, deposit amount, account, previous balance, new balance, available balance, hold amount, available data, available balance, etc. The transaction document may have teller device information 220 in the form of teller identifier number, teller total, operator number, teller name, etc. The transaction document may have user device information 230 in the form of user device identifier number, user device name, etc. Of course, FIG. 2 merely provides one example of a transaction document. The contents of the transaction document may vary based on the transaction and user.

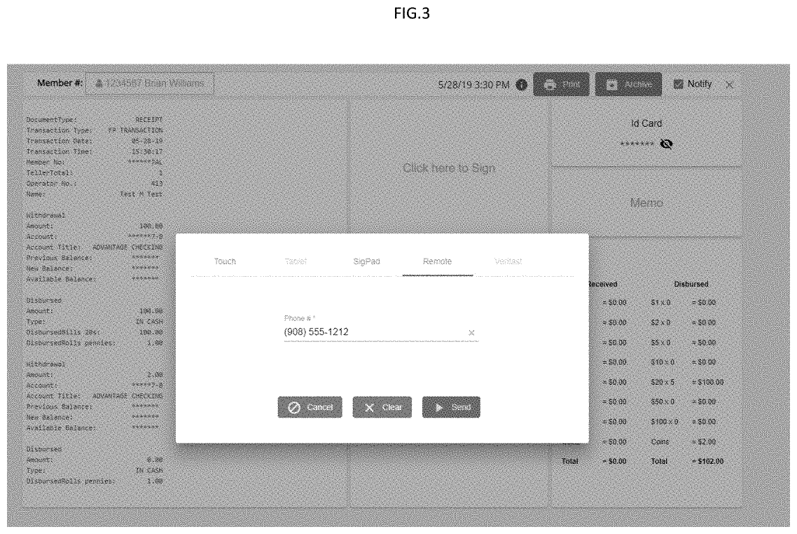

FIG. 3 shows an interface at the teller device for obtaining a user device phone number for the previously described step 130. In an example embodiment, the user device phone number can be auto populated. In another example embodiment, the user device phone number can be input by a human teller associated with the teller device.

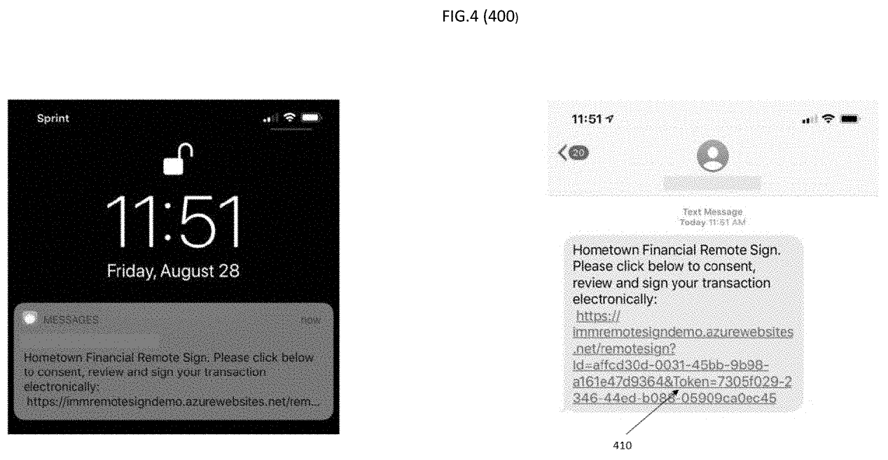

FIG. 4 shows a message received at a user device's interface 400, the message containing the transaction document and an authentication token 410, as previously described steps 130 and 140. In an example embodiment, after message is received the user device may have to agree to terms and conditions before viewing the transaction document.

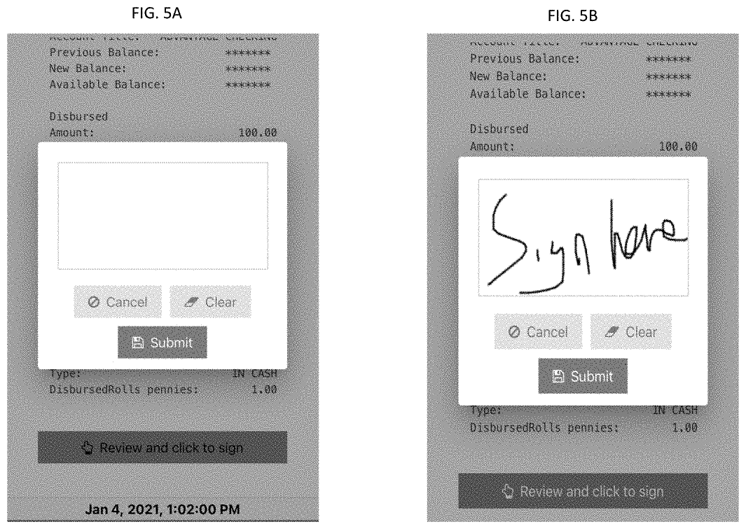

FIG. 5A shows an example display of a webpage includes the transaction document and a signature section, as previously described in step 150. FIG. 5B shows the signature section after the signature has been performed at the user device, as previously described in step 160. If only a portion of the transaction document is displayed, the full document can be displayed by selecting the “Review and click to sign” option near the end of the webpage.

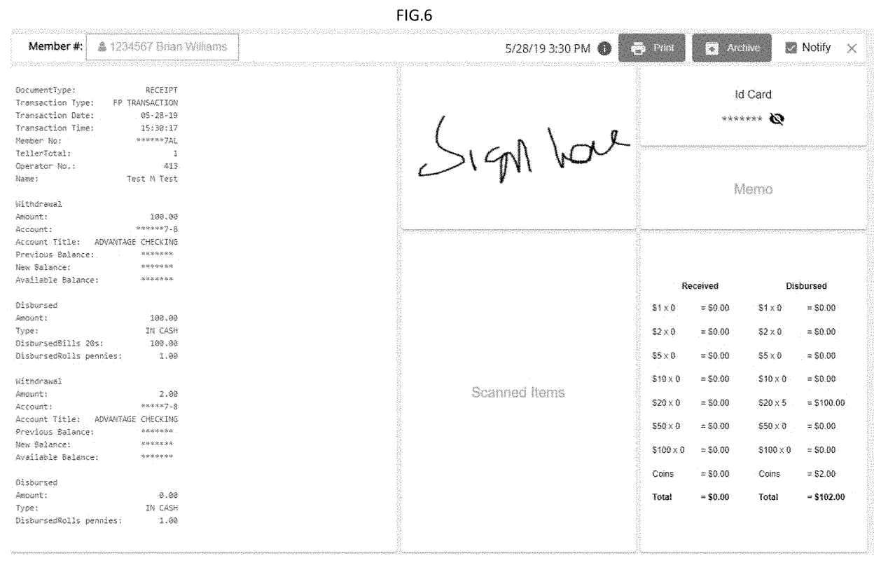

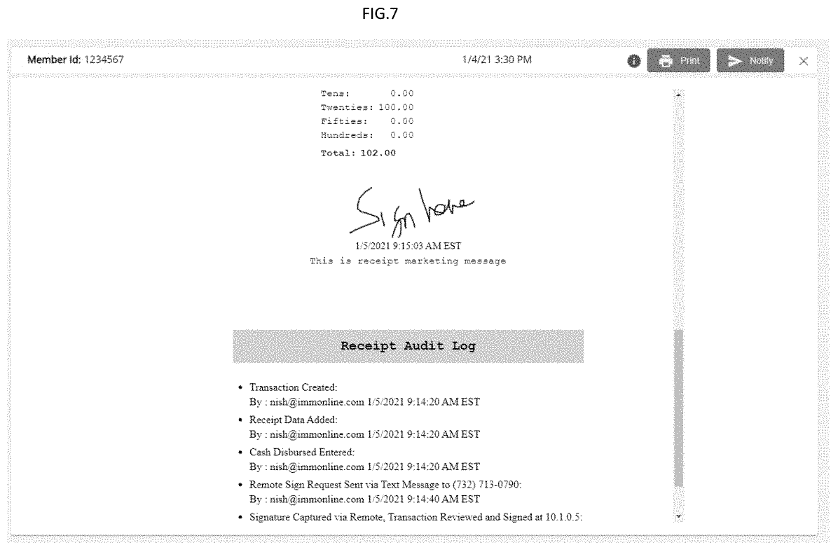

FIG. 6 shows an example display at the teller device's interface showing the performed signature and the transaction document associated with the authorized transaction, as previously described in step 170. FIG. 7 shows an example receipt of the authorized transaction for archiving/auditing/saving, as previously described in step 170.

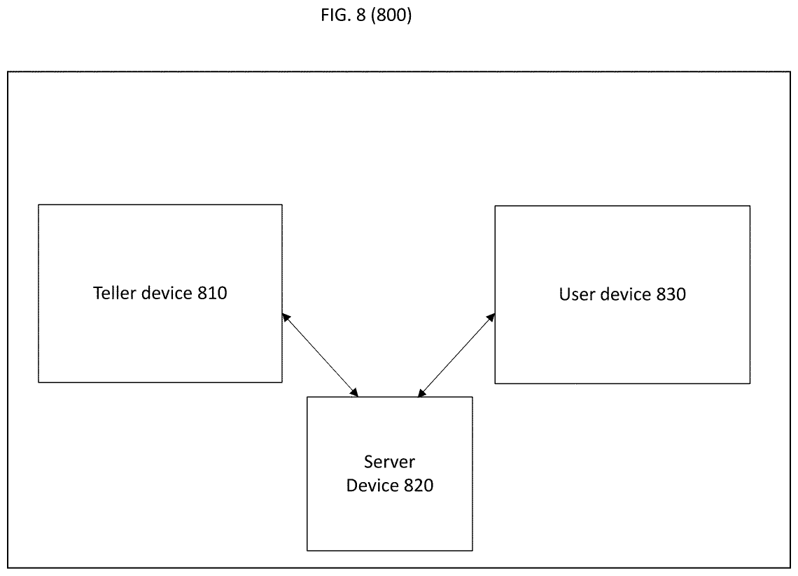

FIG. 8 shows a diagram for a system 800 for authorizing a transaction between a teller device and a user device. The system 800 can include a teller device 810 configured to generate a remote signing notification that includes transaction information associated with the transaction, user information and teller device information associated with the teller device 810. Aspects of the teller device 810 relate to the previously described step 110 of the method 100.

The system 800 can include a server device 820 configured to: receive the remote signing notification from the teller device 810 and generate a transaction document based on the remote signing notification, the transaction document including at least a part of each of the transaction information, the user information, the teller device information, and a first authentication token, store the transaction document and the first authentication token in a database associated with the server device, generate a uniform resource identifier (URI) and a second authentication token based on the transaction document, and transmit, via a messaging gateway, the URI and the second authentication token. Aspects of the server device 820 relate to the previously described steps 120 and 130 of the method 100.

The system 800 can include a user device 830 configured to: receive the second authentication token from the server device 820, receive the first authentication token that is stored in the database of the server device 820, to determine whether a match exists between the first authentication token and the second authentication token, wherein when the match exists, transmit the transaction document from the server device 820 to the user device 830, display a webpage based on the URI, wherein the webpage includes the transaction document and a signature section, and perform a signature in the signature section and transmit the signature from the user device 830 to the server device 820, wherein the server device 820 transmits the signature to the teller device 810 to authorize the transaction.

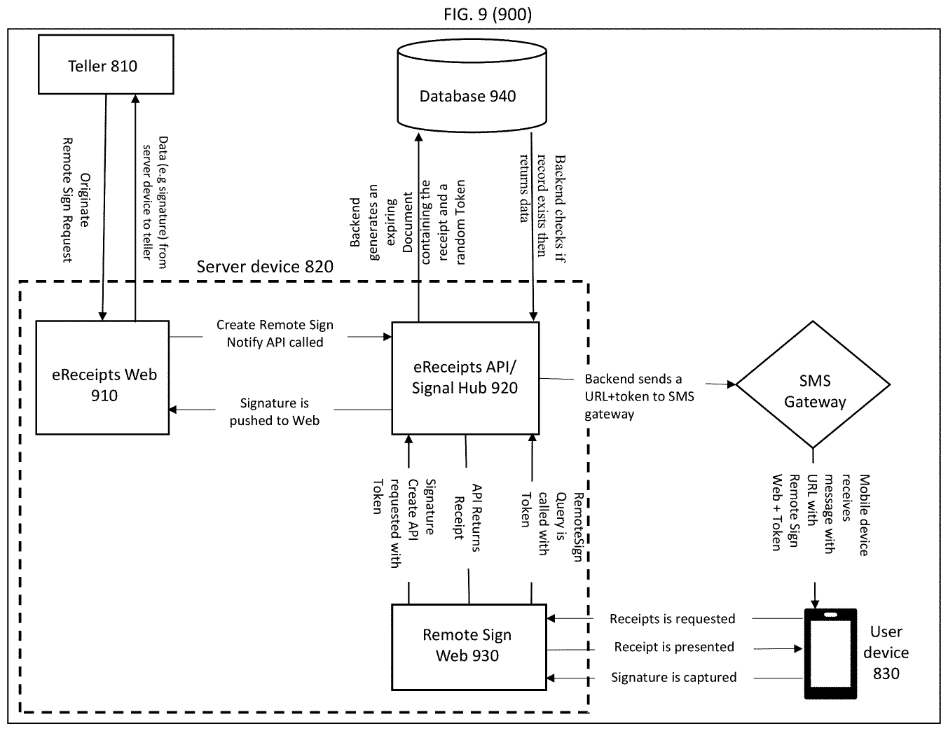

FIG. 9 shows a detailed diagram 900 of the system 800 according to an example embodiment. The server device 820 can include an eReceipts Web module 910, an eReceipts API/Signal Hub 920 module and a remote sign web module 930. The database 940 that interacts with the eReceipts API/Signal Hub 920 module can be based on the server device 820 or can be external to the server device 820. The functions performed by each of the modules 910, 920, 930 and 940 have been previously described with respect to system 800 and method 100.

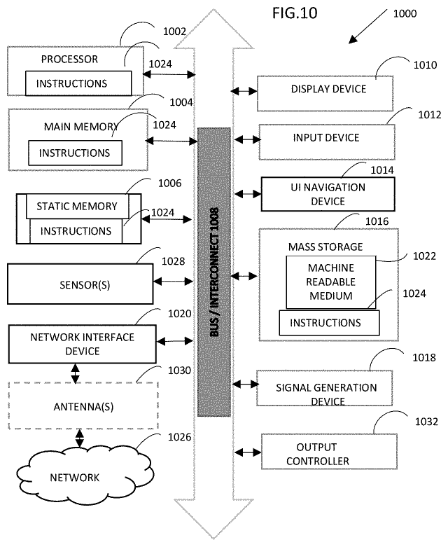

FIG. 10 is a block diagram illustrating an example computing system 1000 upon which any one or more of the methodologies (e.g. method 100 and/or system 800 (e.g. 900)) herein discussed may be run according to an example described herein. Computer system 1000 may be embodied as a computing device, providing operations of the components featured in the various figures, including components of the method 100, system 800, or any other processing or computing platform or component described or referred to herein.

In alternative embodiments, the machine can operate as a standalone device or may be connected (e.g., networked) to other machines. In a networked deployment, the machine may operate in the capacity of either a server or a client machine in server-client network environments, or it may act as a peer machine in peer-to-peer (or distributed) network environments.

Example computer system 1000 includes a processor 1002 (e.g., a central processing unit (CPU), a graphics processing unit (GPU) or both), a main memory 1004 and a static memory 1006, which communicate with each other via an interconnect 1008 (e.g., a link, a bus, etc.). The computer system 1000 may further include a video display unit 1010, an input device 1012 (e.g. keyboard) and a user interface (UI) navigation device 1014 (e.g., a mouse). In one embodiment, the video display unit 1010, input device 1012 and UI navigation device 1014 are a touch screen display. The computer system 1000 may additionally include a storage device 1016 (e.g., a drive unit), a signal generation device 1018 (e.g., a speaker), an output controller 1032, and a network interface device 1020 (which may include or operably communicate with one or more antennas 1030, transceivers, or other wireless communications hardware), and one or more sensors 1028.

The storage device 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004, static memory 1006, and/or within the processor 1002 during execution thereof by the computer system 1000, with the main memory 1004, static memory 1006, and the processor 1002 constituting machine-readable media.

While the machine-readable medium 1022 is illustrated in an example embodiment to be a single medium, the term “machine-readable medium” may include a single medium or multiple medium (e.g., a centralized or distributed database, and/or associated caches and servers) that store the one or more instructions 1024. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of several well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that can store, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the features in the system architecture 1000 of the processing system may be client-operated software or be embodied on a server running an operating system with software running thereon. While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or several components, modules, features, or mechanisms. Such items are tangible entities (e.g., hardware) capable of performing specified operations and may be configured or arranged in a certain manner. In an example, circuits may be arranged (e.g., internally or with respect to external entities such as other circuits) in a specified manner as a module, component, or feature. In an example, the whole or part of one or more computer systems (e.g., a standalone, client or server computer system) or one or more hardware processors may be configured by firmware or software (e.g., instructions, an application portion, or an application) as an item that operates to perform specified operations. In an example, the software may reside on a machine readable medium. In an example, the software, when executed by underlying hardware, causes the hardware to perform the specified operations.

Accordingly, such modules, components, and features are understood to encompass a tangible entity, be that an entity that is physically constructed, specifically configured (e.g., hardwired), or temporarily (e.g., transitorily) configured (e.g., programmed) to operate in a specified manner or to perform part or all operations described herein. Considering examples in which modules, components, and features are temporarily configured, each of the items need not be instantiated at any one moment in time. For example, where the modules, components, and features comprise a general-purpose hardware processor configured using software, the general-purpose hardware processor may be configured as respective different items at different times. Software may accordingly configure a hardware processor, for example, to constitute a particular item at one instance of time and to constitute a different item at a different instance of time.

Additional examples of the presently described method, system, and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

1. A computer-implemented method for authorizing a transaction between a teller device and a user device, the method comprising:
generating, by a teller device, a remote signing notification that includes transaction information associated with the transaction, user information associated with the user device and teller device information associated with the teller device, and transmitting the remote signing notification from the teller device to a server device;
generating, by the server device, a transaction document based on the remote signing notification, the transaction document including at least a part of each of the transaction information, the user information, the teller device information, and a first authentication token, and storing the transaction document and the first authentication token in a database associated with the server device;
generating, by the server device, a uniform resource identifier (URI) and a second authentication token based on the transaction document, and transmitting, via a messaging gateway, the URI and the second authentication token from the server device to the user device;
requesting, by the user device, the first authentication token that is stored in the database of the server device, and determining whether a match exists between the first authentication token and the second authentication token, wherein when the match exists, transmitting the transaction document from the server device to the user device;
displaying, at the user device, a webpage based on the URI, wherein the webpage includes the transaction document and a signature section;
performing, by the user device, a signature in the signature section and transmitting the signature from the user device to the server device; and
transmitting the signature from the server device to the teller device for authorizing the transaction.

2. The method of claim 1, wherein the user information is the user's phone number.

3. The method of claim 1, wherein the transaction information includes transaction identifier, transaction amount and user's account information.

4. The method of claim 1, wherein the transaction document expires after a period of time.

5. The method of claim 1, wherein the messaging gateway is a short message service (SMS) gateway.

6. The method of claim 1, wherein the URI is a uniform resource locater (URL).

7. The method of claim 1, wherein the user device is mobile device.

8. The method of claim 1, wherein the signature is performed via a touchscreen input at the user device.

9. The method of claim 1, wherein the database associated with the server device is based on distributed ledger, relational database, cloud database or in-memory database.

10. A system for authorizing a transaction between a teller device and a user device, the system comprising:
a teller device configured to generate a remote signing notification that includes transaction information associated with the transaction, user information and teller device information associated with the teller device;
a server device configured to:
receive the remote signing notification from the teller device and generate a transaction document based on the remote signing notification, the transaction document including at least a part of each of the transaction information, the user information, the teller device information, and a first authentication token,
store the transaction document and the first authentication token in a database associated with the server device,
generate a uniform resource identifier (URI) and a second authentication token based on the transaction document, and
transmit, via a messaging gateway, the URI and the second authentication token; and
a user device configured to:
receive the second authentication token from the server device,
receive the first authentication token that is stored in the database of the server device, to determine whether a match exists between the first authentication token and the second authentication token, wherein when the match exists, transmit the transaction document from the server device to the user device,
display a webpage based on the URI, wherein the webpage includes the transaction document and a signature section, and
perform a signature in the signature section and transmit the signature from the user device to the server device, wherein the server device transmits the signature to the teller device to authorize the transaction.

11. The system of claim 11, wherein the user information is the user's phone number.

12. The system of claim 11, wherein the transaction information includes transaction identifier, trans-action amount and user's account information.

13. The system of claim 11, wherein the transaction document expires after a period of time.

14. The system of claim 11, wherein the messaging gateway is a short message service (SMS) gateway.

15. The system of claim 11, wherein the URI is a uniform resource locater (URL).

16. The system of claim 11, wherein the user device is mobile device.

17. The system of claim 11, wherein the signature is performed via a touchscreen input at the user device.

18. The system of claim 11, wherein the database associated with the server device is based on distributed ledger, relational database, cloud database or in-memory database.
